(19) United States
(12) Patent Application Publication
(10) Pub. No.: US 2025/0079779 A1
(43) Pub. Date: Mar. 6, 2025

(54) COAXIAL CABLE CONNECTOR

(71) Applicant: Japan Aviation Electronics Industry, Ltd., Tokyo (JP)

(72) Inventors: Takeharu NAITO, Tokyo (JP); Junji OOSAKA, Tokyo (JP); Ryou KATOU, Tokyo (JP); Kazuki ISHII, Tokyo (JP)

(21) Appl. No.: 18/818,372

(22) Filed: Aug. 28, 2024

(30) Foreign Application Priority Data
Aug. 31, 2023 (JP) 2023-140745

(51) Int. Cl. H01R 24/40

(52) U.S. Cl. CPC H01R 24/40

(57) ABSTRACT

Provided is a coaxial cable connector with improved EMS. A relay connector device, which is an example of a coaxial cable connector, includes a contact containing a conductor as a material and extending in an axial direction, an internal housing containing an insulator as the material and supporting the contact in such a way that one end of the contact is exposed, a GND shell containing the conductor as the material and having a part covering at least part of the internal housing, and an EMI shell containing the conductor as the material and having a part covering a clearance of the GND shell. The EMI shell covers, in the clearance, at least any one of the internal housing, the other end of the contact exposed from the internal housing, and a core wire of the cable.

### INCORPORATION BY REFERENCE

This application is based upon and claims the benefit of priority from Japanese patent application No. 2023-140745, filed on Aug. 31, 2023, the disclosure of which is incorporated herein in its entirety by reference.

### BACKGROUND

The present disclosure relates to a coaxial cable connector.

In an on-vehicle coaxial connector, it is essential to improve high-frequency transmission characteristics in terms of performance enhancement. For example, in a coaxial cable connector such as a relay connector device that relays a cable, if there is a clearance in an external shell, electromagnetic compatibility (which is referred to hereinafter as EMC) decreases, which causes an increase in the risk of electro-magnetic interference.

### SUMMARY

In a relay connector device as disclosed in Japanese Unexamined Patent Application Publication No. 2002-190356 (Patent Application No. 2000-389834), for example, a clearance is left in an external shell for manufacturing assembly. Such a clearance causes a decrease in the EMS of the relay connector device.

The present disclosure has been accomplished to solve the above problem, and an object of the present disclosure is thus to provide a coaxial cable connector with improved EMS.

According to an aspect of the present disclosure, a coaxial cable connector is a coaxial cable connector for connecting a cable, including a contact containing a conductor as a material and extending in an axial direction, an insulator body containing an insulator as a material and supporting the contact in such a way that one end of the contact is exposed, a GND shell containing the conductor as the material and having a part covering at least part of the insulator body, and an EMI shell containing the conductor as the material and having a part covering a clearance of the GND shell, wherein the EMI shell covers, in the clearance, at least any one of the insulator body, the contact exposed from the insulator body, and a core wire of the cable connected to another end of the contact.

In the above-described coaxial cable connector, the cable may include the core wire containing the conductor as the material and connected to the another end of the contact, a coating containing the insulator as the material and having a part covering the core wire, a shield containing the conductor as the material and having a part covering the coating, and an outside cover containing the insulator as the material and having a part covering the shield, and the EMI shell may cover, in the clearance, at least any one of the insulator body, the contact exposed from the insulator body, the coating exposed from the shield, and the core wire exposed from the coating and connected to the another end of the contact.

The above-described coaxial cable connector may further include a sleeve having a part covering the shield exposed from the outside cover, the EMI shell may include a first part covering the insulator body with the GND shell interposed therebetween, and a second part covering the sleeve with the GND shell interposed therebetween, and a width of the first part in a specified direction orthogonal to the axial direction may be different from a width of the second part in the specified direction.

In the above-described coaxial cable connector, the GND shell may include a first retention part, and the EMI shell may include a second retention part configured to mate with the first retention part.

In the above-described coaxial cable connector, the EMI shell may be joined to the GND shell.

In the above-described coaxial cable connector, the EMI shell may be joined to the GND shell by laser welding.

In the above-described coaxial cable connector, the EMI shell may be joined to the GND shell in close proximity to an edge on one end of the EMI shell.

According to the present disclosure, there is provided a coaxial cable connector with improved EMS.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a sectional view illustrating a relay connector device according to a comparative example;

FIG. 2 is a perspective view illustrating a connector in the relay connector device according to the comparative example;

FIG. 3 is a perspective view illustrating a connector in the relay connector device according to the comparative example;

FIG. 4 is an exploded perspective view illustrating each member constituting the connector in the relay connector device according to the comparative example;

FIG. 5 is an exploded perspective view illustrating each member constituting the connector in the relay connector device according to the comparative example;

FIG. 6 is a sectional view illustrating the operation of connecting connectors in the relay connector device according to the comparative example;

FIG. 7 is a perspective view illustrating the connector in the relay connector device according to the comparative example, which shows an enlarged view of a part VII in FIG. 3;

FIG. 8 is a sectional view illustrating a relay connector device according to a first embodiment;

FIG. 9 is a perspective view illustrating a connector in the relay connector device according to the first embodiment;

FIG. 10 is a perspective view illustrating a connector in the relay connector device according to the first embodiment;

FIG. 11 is an exploded perspective view illustrating each member constituting the connector in the relay connector device according to the first embodiment;

FIG. 12 is an exploded perspective view illustrating each member constituting the connector in the relay connector device according to the first embodiment;

FIG. 13 is a perspective view illustrating an EMI shell in the relay connector device according to the first embodiment;

FIG. 14 is a side view illustrating the connector from which the EMI shell is removed in the relay connector device according to the first embodiment;

FIG. 15 is a perspective view illustrating the connector from which the EMI shell is removed in the relay connector device according to the first embodiment;

FIG. 16 is a cross-sectional perspective view illustrating the connector from which the EMI shell is removed in the relay connector device according to the first embodiment;

FIG. 17 is a side view illustrating the connector in the relay connector device according to the first embodiment, where the EMI shell is shown transparent;

FIG. 18 is a sectional view illustrating the connector in the relay connector device according to the first embodiment, which shows a cross section XVIII in FIG. 10;

FIG. 19 is a sectional view illustrating the connector in the relay connector device according to the first embodiment, which shows a cross section XIX in FIG. 10;

FIG. 20 is a perspective view illustrating a connector in the relay connector device according to the first embodiment;

FIG. 21 is a sectional view illustrating the operation of connecting connectors in the relay connector device according to the first embodiment;

FIG. 22 is a graph illustrating EMI characteristics in the relay connector device according to the first embodiment, where the horizontal axis indicates the frequency of a signal and the vertical axis indicates the magnitude of a signal;

FIG. 23 is a view illustrating noise leakage to the outside in the relay connector device according to the comparative example; and

FIG. 24 is a view illustrating noise leakage to the outside in the relay connector device according to the first embodiment.

### DESCRIPTION OF EMBODIMENTS

A specific structure of the present disclosure will be described hereinbelow with reference to the drawings. The description provided hereinbelow merely illustrates a preferred embodiment of the present disclosure, and the present disclosure is not limited to the below-described embodiment. In the following description, the identical reference symbols denote substantially identical elements. For clarity of the drawings, some reference symbols and hatching are omitted.

A coaxial cable connector according to this embodiment will be described. In the following, a relay connector device that relays a cable will be described as an example of the coaxial cable connector according to this embodiment. Note that the coaxial cable connector according to this embodiment is not limited to the relay connector device, and it may include another connector device such as a coaxial connector device where a cable mates with a board as long as it is configured to connect a coaxial cable. Prior to describing a relay connector device according to a first embodiment, a relay connector device according to a comparative example will be described for comparison. This will clarify the features of the relay connector device according to the first embodiment. Note that the comparative example is also included in the technical idea of this embodiment.

### Comparative Example

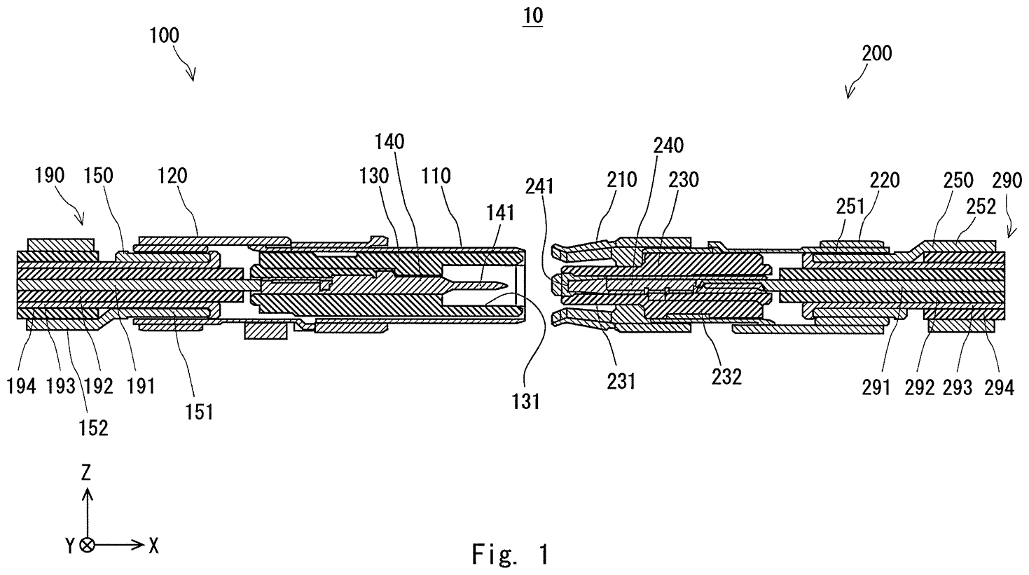

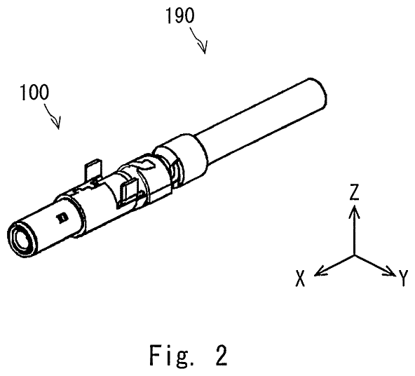

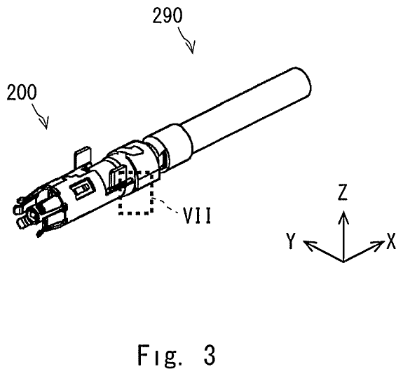

The relay connector device according to the comparative example is described hereinafter. FIG. 1 is a sectional view illustrating a relay connector device 10 according to a comparative example. FIG. 2 is a perspective view illustrating a connector 100 in the relay connector device 10 according to the comparative example. FIG. 3 is a perspective view illustrating a connector 200 in the relay connector device 10 according to the comparative example. In FIGS. 1 to 3, an external housing is omitted. Note that the relay connector device 10 may be used in separation from the external housing.

As shown in FIGS. 1 to 3, the relay connector device 10 according to the comparative example includes the connector 100 and the connector 200. The connector 100 is the connector 100 on the male side, for example, and the connector 200 is the connector 200 on the female side, for example. The connector 100 is connected to an end of a cable 190. The connector 200 is connected to an end of a cable 290. The connector 100 is connected to the connector 200. The relay connector device 10 thereby connects the cable 190 and the cable 290.

For the convenience of description of the relay connector device 10 and a relay connector device 20, which is described later, the xyz-orthogonal coordinate axis system is used. For example, an axial direction that is coaxial with the relay connector device 10 or the like is referred to as x axis direction. A direction where the connector 100 on the male side is headed to the connector 200 on the female side when connecting the connector 100 and the connector 200 is referred to as +x direction. Two directions orthogonal to the x axis are referred to as y axis direction and z axis direction.

### <Male-Side Connector>

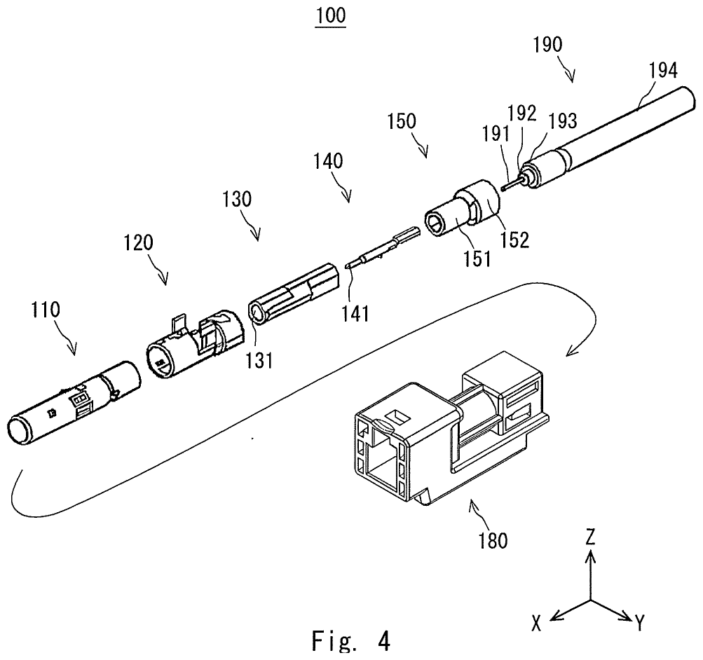

The connector 100 on the male side is described hereinafter. FIG. 4 is an exploded perspective view illustrating each member constituting the connector 100 in the relay connector device 10 according to the comparative example. As shown in FIGS. 1 to 2 and FIG. 4, the connector 100 includes a GND shell 110, a GND shell 120, an internal housing 130, a contact 140, a sleeve 150, and an external housing 180. Each member is described hereinbelow.

### <GND Shell>

The GND shell 110 and the GND shell 120 contain a conductor as a material. For example, the GND shell 110 and the GND shell 120 contain a metal as a material. Note that the GND shell 110 and the GND shell 120 may contain a material other than a metal as long as it contains a conductor. The GND shell 110 and the GND shell 120 are electrically connected to a ground potential.

The GND shell 110 and the GND shell 120 have a tube shape. For example, the GND shell 110 and the GND shell 120 have a cylindrical shape. The GND shell 110 and the GND shell 120 are disposed in such a way that their center axes are in the x axis direction. The center axes of the GND shell 110 and the GND shell 120 coincide with each other. The GND shell 110 is disposed on the +x axis direction side of the GND shell 120. The GND shell 110 may partly overlap the GND shell 120. For example, a part of the GND shell 110 on the −x axis direction side overlaps a part of the GND shell 120 on the +x axis direction side. The GND shell 110 and the GND shell 120 integrally have a cylindrical shape.

The internal housing 130 and the contact 140 are disposed inside the GND shell 110 and the GND shell 120. The sleeve 150 and a part of the cable 190 may be disposed inside the GND shell 120. Thus, the GND shell 110 and the GND shell 120 have a part that covers at least part of the internal housing 130. The internal housing 130 may be press-fit to the inside of the GND shell 110.

An end of the GND shell 110 on the +x axis direction side is disposed in close proximity to an end of the internal housing 130 on the +x axis direction side. The position on the x axis of the end of the GND shell 110 on the +x axis direction side may coincide with that of the end of the internal housing 130 on the +x axis direction side. An end of the GND shell 120 on the −x axis direction side is located above an outside cover 194 of the cable 190. The end of the GND shell 120 on the −x axis direction side is disposed in close proximity to an end of the sleeve 150 on the −x axis direction side. For example, the position on the x axis of the end of the GND shell 120 on the −x axis direction side may coincide with that of the end of the sleeve 150 on the −x axis direction side.

### <Internal Housing>

The internal housing 130 contains an insulator as a material. The internal housing 130 is also called an insulator body. For example, the internal housing 130 contains a resin as a material. Note that the internal housing 130 may contain a material other than a resin as long as it contains an insulator.

The internal housing 130 has a tube shape. For example, the internal housing 130 has a cylindrical shape. The internal housing 130 is disposed in such a way that its center axis is in the x axis direction. The internal housing 130 is disposed inside the GND shell 110. The contact 140 is disposed inside the internal housing 130. Thus, the internal housing 130 supports the contact 140. The contact 140 disposed inside the internal housing 130 may be press-fit into the internal housing 130.

The internal housing 130 has a recess 131 in its end surface on the +x axis direction side. An end of the contact 140 on the +x axis direction side projects from a bottom surface of the recess 131. One end of the contact 140 on the +x axis direction side includes a projection 141. A side wall of the recess 131 of the internal housing 130 surrounds the end of the contact 140 on the +x axis direction side.

An end of the internal housing 130 on the −x axis direction side is located in close proximity to an end of the contact 140 on the −x axis direction side. For example, the position on the x axis of the end of the internal housing 130 on the −x axis direction side may coincide with that of another end of the contact 140 on the −x axis direction side. A core wire 191 of the cable 190 is connected to the end of the contact 140 on the −x axis direction side. A connection part between the contact 140 and the core wire 191 of the cable 190 may be disposed inside the internal housing 130.

### <Contact>

The contact 140 contains a conductor as a material. For example, the contact 140 contains a metal as a material. Note that the contact 140 may contain a material other than a metal as long as it contains a conductor. The contact 140 serves as a transmission path of a high-frequency signal, for example.

The contact 140 has a bar shape. The contact 140 is disposed in such a way that its center axis is in the x axis direction. Thus, the contact 140 has a shape extending in the axial direction. The contact 140 has the projection 141 at one end on the +x axis direction side. The contact 140 is disposed inside the internal housing 130. The other end of the contact 140 on the −x axis direction side is connected to the core wire 191 of the cable 190. The projection 141 at one end of the contact 140 on the +x axis direction side is connected to a contact 240 of the connector 200 on the female side. The projection 141 of the contact 140 has a projecting shape to mate with a recess 241 of the contact 240.

### <Sleeve>

The sleeve 150 contains a conductor as a material. For example, the sleeve 150 contains a metal as a material. Note that the sleeve 150 may contain a material other than a metal as long as it contains a conductor.

The sleeve 150 has a tube shape. For example, the sleeve 150 has a cylindrical shape. The sleeve 150 is disposed in such a way that its center axis is in the x axis direction. The sleeve 150 includes a first part 151 in cylindrical shape and a second part 152 in cylindrical shape. The first part 151 and the second part 152 are connected in parallel in the x axis direction. The first part 151 is disposed on the +x axis direction side of the second part 152. The outside diameter of the first part 151 is smaller than the outside diameter of the second part 152. The inside diameter of the first part 151 is smaller than the inside diameter of the second part 152.

The first part 151 is disposed inside the GND shell 120. The first part 151 has a part that covers a shield 193 exposed from an end of the outside cover 194 of the cable 190. The second part 152 covers the outside cover 194 of the cable 190. A connection part between the first part 151 and the second part 152 is located in close proximity to an end of the outside cover 194 on the +x axis direction side.

### <External Housing>

The external housing 180 contains an insulator as a material. For example, the external housing 180 contains a resin as a material. Note that the external housing 180 may contain a material other than a resin as long as it contains an insulator.

The external housing 180 has a tube shape. For example, the external housing 180 has a square tube shape. The external housing 180 is disposed in such a way that its center axis is in the x axis direction. An assembly of the GND shell 110, the GND shell 120, the internal housing 130, the contact 140, and the sleeve 150 is mounted inside the external housing 180.

### <Cable>

The structure of the cable 190 is described hereinafter. The cable 190 extends in one direction and has flexibility. The cable 190 includes the core wire 191, a coating 192, a shield 193, and the outside cover 194. The core wire 191, the coating 192, the shield 193, and the outside cover 194 are disposed in concentric layers. Those members are stacked concentrically with the core wire 191 at the center. When the cable 190 extends in the x axis direction, those members are stacked concentrically with their center axes in the x axis direction. The coating 192 covers a side surface of the core wire 191. The shield 193 covers a side surface of the coating 192. The outside cover 194 covers a side surface of the shield 193.

The core wire 191 contains a conductor as a material. The core wire 191 has a linear shape. The core wire 191 may contain a copper wire, for example. Note that the core wire 191 may contain a material other than a copper wire as long as it contains a linear conductor. A part of the core wire 191 on the +x axis direction side projects from an end of the coating 192 on the +x axis direction side. The core wire 191 is connected to the other end of the contact 140 on the −x axis direction side.

The coating 192 contains an insulator as a material. For example, the coating 192 contains a resin as a material. Note that the coating 192 may contain a material other than a resin as long as it contains an insulator. The coating 192 has a tube shape. The coating 192 has a part that covers the side surface of the core wire 191. The end of the coating 192 on the +x axis direction side may be a cut surface. A part of the coating 192 on the +x axis direction side may be exposed from an end of the shield 193 on the +x axis direction side.

The shield 193 contains a conductor as a material. For example, the shield 193 may contain a metal. Note that the shield 193 may contain a material other than a metal as long as it contains a conductor. The shield 193 has a tube shape. The shield 193 has a part that covers the side surface of the coating 192. The end of the shield 193 on the +x axis direction side is folded to the −x axis direction side. To be specific, the end of the shield 193 on the +x axis direction side is folded to the −x axis direction side along an edge of the first part 151 of the sleeve 150 on the +x axis direction side. The end of the folded shield 193 on the +x axis direction side is connected to an inner surface of the GND shell 120. Thus, the shield 193 is electrically connected to the ground potential. A part of the shield 193 on the +x axis direction side may be exposed from an end of the outside cover 194 on the +x axis direction side.

The outside cover 194 contains an insulator as a material. For example, the outside cover 194 may contain a resin. The outside cover 194 may contain a material other than a resin as long as it contains an insulator. The outside cover 194 has a tube shape. The outside cover 194 has a part that covers the side surface of the shield 193. The end of the outside cover 194 on the +x axis direction side may be a cut surface. A part of the outside cover 194 on the +x axis direction side may be covered with at least any one of the sleeve 150 and the GND shell 120.

### <Female-Side Connector>

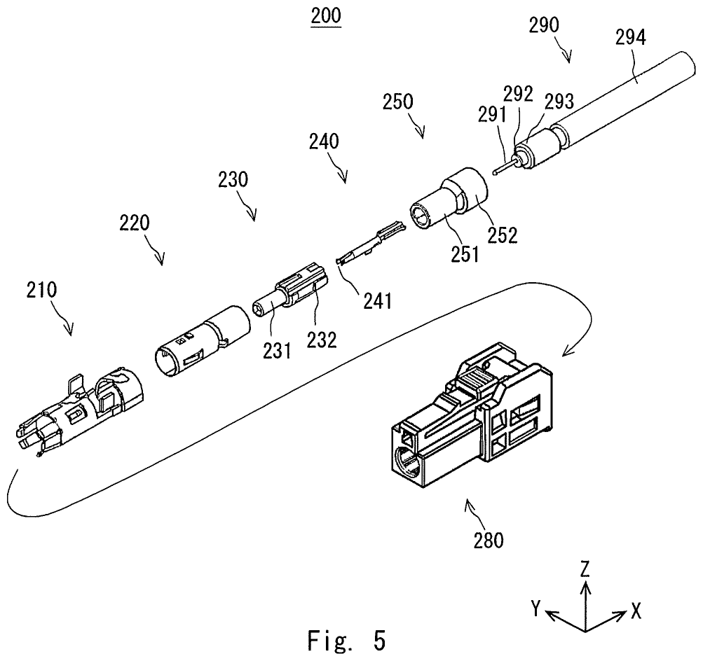

The connector 200 on the female side is described hereinafter. FIG. 5 is an exploded perspective view illustrating each member constituting the connector 200 in the relay connector device 10 according to the comparative example. As shown in FIG. 1, FIG. 3, and FIG. 5, the connector 200 includes a GND shell 210, a GND shell 220, an internal housing 230, a contact 240, a sleeve 250, and an external housing 280.

In the case of the connector 100, the cable 190 is located on the −x axis direction side of the connector 100, whereas in the case of the connector 200, the cable 290 is located on the +x axis direction side of the connector 200. Otherwise, the basic structures and functions of the GND shell 210, the GND shell 220, the internal housing 230, the contact 240, the sleeve 250, and the external housing 280 of the connector 200 are the same as the structures and functions of the GND shell 110, the GND shell 120, the internal housing 130, the contact 140, the sleeve 150, and the external housing 180 of the connector 100, respectively.

### <GND Shell>

The GND shell 210 is disposed on the −x axis direction side of the GND shell 220. The internal housing 230 and the contact 240 are disposed inside the GND shell 210 and the GND shell 220. The sleeve 250 and the cable 290 may be disposed inside the GND shell 220. The internal housing 230 may be press-fit to the inside of the GND shell 210.

An end of the GND shell 210 on the −x axis direction side is disposed in close proximity to an end of the internal housing 230 on the −x axis direction side. The position on the x axis of the end of the GND shell 210 on the −x axis direction side may coincide with that of the end of the internal housing 230 on the −x axis direction side. An end of the GND shell 220 on the +x axis direction side is located above an outside cover 294 of the cable 290. The end of the GND shell 220 on the +x axis direction side is disposed in close proximity to an end of the sleeve 250 on the +x axis direction side. For example, the position on the x axis of the end of the GND shell 220 on the +x axis direction side may coincide with that of the end of the sleeve 250 on the +x axis direction side.

### <Internal Housing>

The internal housing 230 is disposed inside the GND shell 210. The contact 240 is disposed inside the internal housing 230. Thus, the contact 240 is disposed inside the GND shell 210. The internal housing 230 supports the contact 240.

The internal housing 230 includes a first part 231 and a second part 232. The first part 231 is disposed on the −x axis direction side of the second part 232. The first part 231 and the second part 232 have a cylindrical shape whose center axis coincides with the center axis of the internal housing 230. The outside diameter of the first part 231 is smaller than the outside diameter of the second part 232. The first part 231 mates with the recess 131 of the internal housing 130 of the connector 100. When the first part 231 mates with the recess 131, the projection 141 of the contact 140 of the connector 100 mates with the recess 241 of the contact 240 of the connector 200.

An end of the internal housing 230 on the −x axis direction side is an end surface of the first part 231 on the −x axis direction side. The end of the internal housing 230 on the −x axis direction side is disposed in close proximity to an end of the GND shell 210 on the −x axis direction side. For example, the position on the x axis of the end of the internal housing 230 on the −x axis direction side may coincide with that of the end of the GND shell 210 on the −x axis direction side. The recess 241 on the −x axis direction side of the contact 240 is disposed inside the first part 231.

An end of the internal housing 230 on the +x axis direction side is disposed in close proximity to an end of the contact 240 on the +x axis direction side. For example, the position on the x axis of the end of the internal housing 230 on the +x axis direction side may coincide with that of another end of the contact 240 on the +x axis direction side. A core wire 291 of the cable 290 is connected to the end of the contact 240 on the +x axis direction side. A connection part between the contact 240 and the core wire 291 of the cable 290 may be disposed inside the internal housing 230.

### <Contact>

The contact 240 has the recess 241 at one end on the −x axis direction side. The contact 240 is disposed inside the internal housing 230. An end of the contact 240 on the +x axis direction side is connected to the core wire 291 of the cable 290. The projection 141 of the contact 140 mates with the recess 241 of the contact 240.

### <Sleeve>

The sleeve 250 includes a first part 251 in cylindrical shape and a second part 252 in cylindrical shape. The first part 251 is disposed on the −x axis direction side of the second part 252. The outside diameter of the first part 251 is smaller than the outside diameter of the second part 252. The inside diameter of the first part 251 is smaller than the inside diameter of the second part 252.

The first part 251 is disposed inside the GND shell 220. The first part 251 covers a shield 293 that is exposed from an end of the outside cover 294 of the cable 290. The second part 252 covers the outside cover 294 of the cable 290. A connection part between the first part 251 and the second part 252 is thus located in close proximity to an end of the outside cover 294.

### <Cable>

The cable 290 includes the core wire 291, a coating 292, the shield 293, and the outside cover 294. The structures and functions of the core wire 291, the coating 292, the shield 293, and the outside cover 294 in the cable 290 are the same as the structures and functions of the core wire 191, the coating 192, the shield 193, and the outside cover 194 in the cable 190, respectively. Note that, however, the direction in which the core wire 291 connects to the contact 240, the direction of the end surface of the coating 292 having the cut surface, the direction of the end of the shield 293 and the direction in which it is folded, the direction of the end surface of the outside cover 294 and the like are opposite to those in the cable 190.

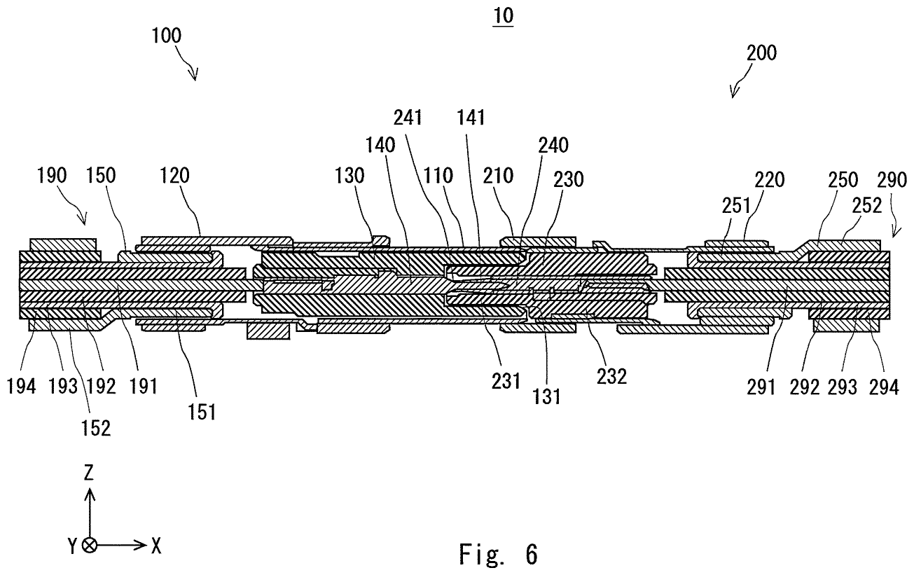

The operation of connection of the relay connector device 10 according to the comparative example is described hereinafter. FIG. 6 is a sectional view illustrating the operation of connecting the connectors 100 and 200 in the relay connector device according to the comparative example. As shown in FIGS. 1 and 6, in the relay connector device 10 according to the comparative example, the connector 100 and the connector 200 are opposed to each other. Then, the projection 141 of the contact 140 mates with the recess 241 of the contact 240. A transmission path of a high-frequency signal is thereby formed between the contact 140 and the contact 240. At the same time, the first part 231 of the internal housing 230 mates with the recess 131 of the internal housing 130. Further, the GND shell 110 and the GND shell 210 come into contact with each other. A shield that covers the transmission path of a high-frequency signal is thereby formed.

### <Problem in Comparative Example>

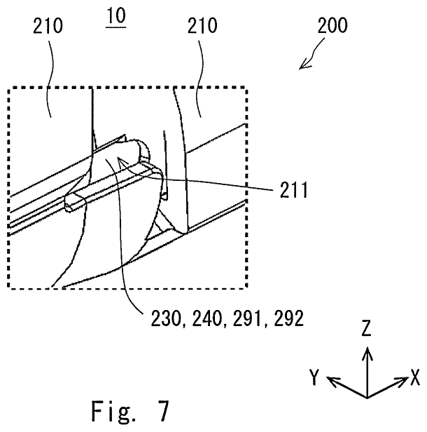

FIG. 7 is a perspective view illustrating the connector 200 in the relay connector device 10 according to the comparative example, which shows an enlarged view of the part VII in FIG. 3. As shown in FIG. 7, in the relay connector device 10 according to the comparative example, the GND shell 210 in the connector 200 has a clearance 211. The connector 200 has a structure where the GND shell 210 is covered with the GND shell 220 for manufacturing assembly. For example, the GND shell 220 is fit into the GND shell 210 by using the elasticity of the GND shell 210 and the GND shell 220 that bend in the radial direction. The GND shell 210 and the GND shell 220 are thereby electrically connected.

The connector 200 has a structure where the clearance 211 of the GND shell 210 is covered with the GND shell 220; however, as shown in FIG. 7, it is difficult to completely cover the contact 240 or the like through which a signal flows with the GND shell 210 and the GND shell 220. For example, the internal housing 230, the other end of the contact 240 exposed from the internal housing 230, the coating 292 exposed from the shield 293, the core wire 291 exposed from the coating 292 and the like can be seen from the outside through the clearance 211 in some cases. Then, noise can be leaked to the outside of the connector 200, which makes it difficult to improve the EMC.

### First Embodiment

A relay connector device according to the first embodiment is described hereinafter. In this embodiment, a clearance of a GND shell is covered with an EMI shell. This improves the EMC.

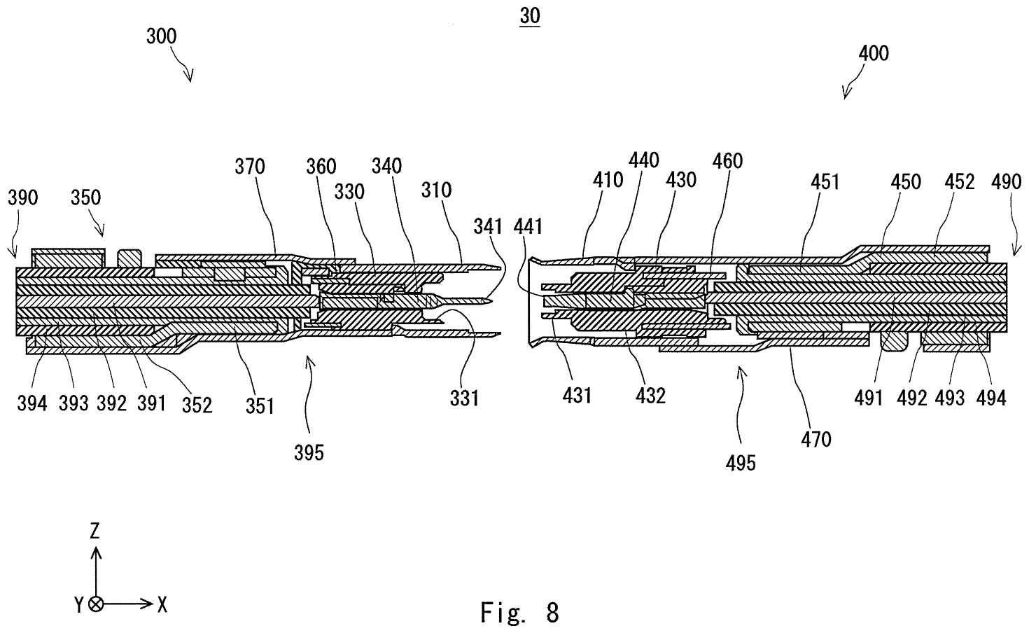

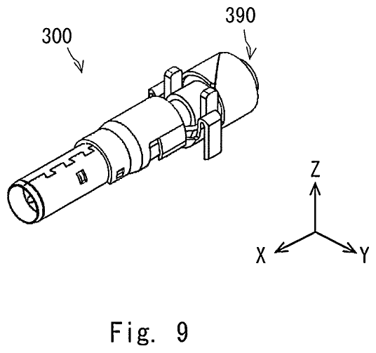

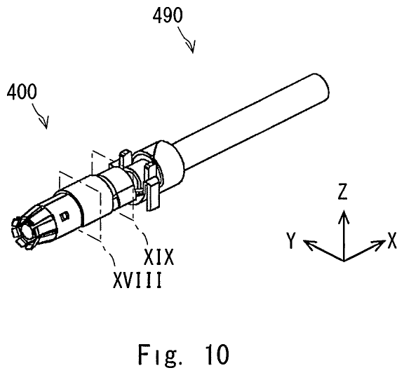

FIG. 8 is a sectional view illustrating the relay connector device 30 according to the first embodiment. FIG. 9 is a perspective view illustrating a connector 300 in the relay connector device 30 according to the first embodiment. FIG. 10 is a perspective view illustrating a connector 400 in the relay connector device 30 according to the first embodiment. In FIGS. 8 to 10, an external housing is omitted. Note that the relay connector device 30 may be used in separation from the external housing.

As shown in FIGS. 8 to 10, the relay connector device 30 according to this embodiment includes the connector 300 and the connector 400. The connector 300 is the connector 300 on the male side, and the connector 400 is the connector 400 on the female side, for example. The connector 300 is connected to an end of a cable 390. The connector 400 is connected to an end of a cable 490. The connector 300 is connected to the connector 400. The relay connector device 30 thereby connects the cable 390 and the cable 490.

### <Male-Side Connector>

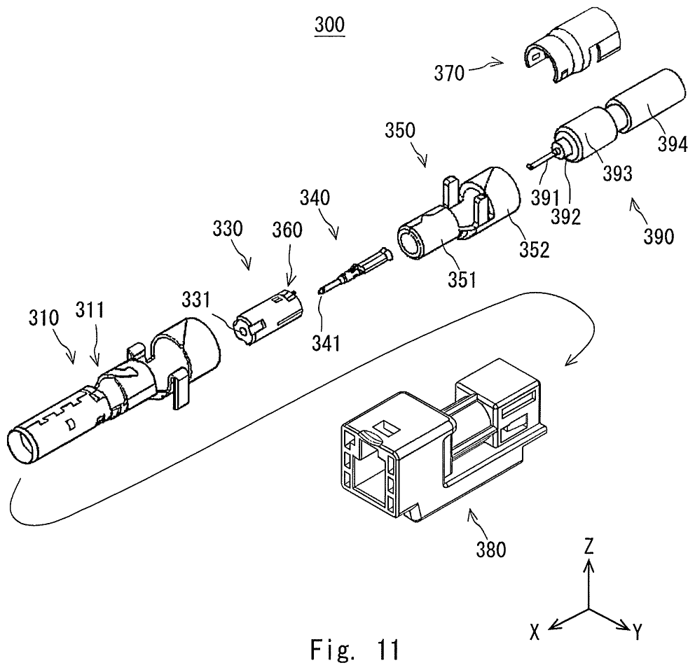

FIG. 11 is an exploded perspective view illustrating each member constituting the connector 300 in the relay connector device 30 according to the first embodiment. As shown in FIGS. 8 to 9 and FIG. 11, the connector 300 includes a GND shell 310, the internal housing 330, a contact 340, a sleeve 350, the impedance adjuster 360, an EMI shell 370, and an external housing 380. The basic structures and functions of the GND shell 310, the internal housing 330, the contact 340, the sleeve 350, and the external housing 380 in the connector 300 are the same as the structures and functions of the GND shells 110 and 120, the internal housing 130, the contact 140, the sleeve 150, and the external housing 180 in the connector 100, respectively. Note that the connector 300 does not necessarily include the impedance adjuster 360.

### <GND Shell>

The GND shell 310 corresponds to an integrated combination of the GND shells 110 and 120 in the connector 100. The internal housing 330, the contact 340, and the impedance adjuster 360 are disposed inside the GND shell 310. Further, the sleeve 350 and a part of the cable 390 are disposed inside the GND shell 310. The GND shell 310 has a part that covers at least part of the internal housing 330. The internal housing 330 may be press-fit to the inside of the GND shell 310.

An end of the GND shell 310 on the +x axis direction side is disposed in close proximity to an end of the internal housing 330 on the +x axis direction side. On the other hand, an end of the GND shell 310 on the −x axis direction side is located above an outside cover 394 of the cable 390. The position on the x axis of the end of the GND shell 310 on the −x axis direction side may coincide with that of an end of the sleeve 350 on the −x axis direction side.

### <Internal Housing>

The internal housing 330 may incorporate a part of the impedance adjuster 360. For example, a part of the internal housing 330 on the −x axis direction side incorporates a part of the impedance adjuster 360 on the +x axis direction side. Note that, when the connector 300 does not include the impedance adjuster 360, the internal housing 330 does not necessarily incorporate the impedance adjuster 360.

The internal housing 330 is disposed inside the GND shell 310. The contact 340 is disposed inside the internal housing 330. The internal housing 330 supports the contact 340 inside. The internal housing 330 has a recess 331 in its end surface on the +x axis direction side. One end of the contact 340 on the +x axis direction side is exposed from a bottom surface of the recess 331. Thus, the internal housing 330 supports the contact 340 inside in such a way that one end of the contact 340 is exposed. One end of the contact 340 on the +x axis direction side includes a projection 341. A side wall of the recess 331 of the internal housing 330 surrounds the projection 341 of the contact 340 on the +x axis direction side.

An end of the internal housing 330 on the −x axis direction side is disposed in close proximity to an end of the contact 340 on the −x axis direction side. For example, the position on the x axis of the end of the internal housing 330 on the −x axis direction side may coincide with that of another end of the contact 340 on the −x axis direction side. A core wire 391 of the cable 390 is connected to the end of the contact 340 on the −x axis direction side. A connection part between the contact 340 and the core wire 391 may be disposed inside the internal housing 330.

### <Contact>

The contact 340 has the projection 341 at one end on the +x axis direction side. One end of the contact 340 on the +x axis direction side is connected to a contact 440 of the connector 400 on the female side. The projection 341 of the contact 340 on the +x axis direction side has a projecting shape to mate with the contact 440. The other end of the contact 340 on the −x axis direction side is connected to a core wire 391 of the cable 390.

### <Sleeve>

The sleeve 350 includes a first part 351 in cylindrical shape and a second part 352 in cylindrical shape. The first part 351 is disposed inside the GND shell 310. The first part 351 covers a shield 393 that is exposed from an end of the outside cover 394 of the cable 390. The second part 352 covers the outside cover 394 of the cable 390. A connection part between the first part 351 and the second part 352 is thus located in close proximity to an end of the outside cover 394.

### <Impedance Adjuster>

The impedance adjuster 360 has a part incorporated into the internal housing 330. To be specific, for example, a part of the impedance adjuster 360 on the +x axis direction side is incorporated into a part of the internal housing 330 on the −x axis direction side. The impedance adjuster 360 may be incorporated into the internal housing 330 by insert molding. Alternatively, the impedance adjuster 360 may be incorporated into the internal housing 330 by being press-fit into the internal housing 330.

The impedance adjuster 360 contains a conductor. For example, the impedance adjuster 360 contains a metal as a material. Note that the impedance adjuster 360 may contain a material other than a metal as long as it contains a conductor. The impedance adjuster 360 may be electrically isolated from the contact 340 and the core wire 391, which are a transmission path of a high-frequency signal, and may be electrically isolated from the ground potential. In other words, the impedance adjuster 360 may be a hollow ground potential that is not directly connected to another conductor. This eliminates the need for a circuit for connecting the impedance adjuster 360 to another conductor and reduces the impedance near a spatial layer 395 containing air in the relay connector device 30, thereby improving the impedance matching.

Note that the impedance adjuster 360 may be electrically connected to the ground potential. For example, the impedance adjuster 360 may be connected to the GND shell 310 so that the impedance adjuster 360 is held at electrically ground potential. This allows reducing the impedance near the spatial layer 395 containing air in the relay connector device 30, thereby improving the impedance matching.

The impedance adjuster 360 has a tube shape. For example, the impedance adjuster 360 has a cylindrical shape. The impedance adjuster 360 is disposed in such a way that its center axis is in the x axis direction. Thus, the impedance adjuster 360 has a tube shape with its center axis located at the contact 340 and the core wire 391 of the cable 390.

Note that the impedance adjuster 360 may have a square tube shape or may have a square tube shape whose corners are rounded as long as it has a tube shape. Further, the impedance adjuster 360 may have a tube shape where a plurality of members are combined into tube shape or may have a cut in a part of a tube shape. The impedance adjuster 360 adjusts the impedance by surrounding the contact 340 and the core wire 391 at the center axis, and thereby improves the impedance matching.

The impedance adjuster 360, together with the internal housing 330 and the contact 340, is disposed inside the GND shell 310. An end of the impedance adjuster 360 on the +x axis direction side is located inside the internal housing 330. An end of the impedance adjuster 360 on the −x axis direction side is located above a coating 392 of the cable 390. An end of the coating 392 on the +x axis direction side of the cable 390 is a cut surface. Thus, the impedance adjuster 360 covers the end of the coating 392. The impedance adjuster 360 thereby covers an exposed part of the core wire 391.

As described above, the impedance adjuster 360 covers an exposed part of the core wire 391 connected to the contact 340, which is exposed from the internal housing 330. The spatial layer 395 is formed between the exposed part of the core wire 391 connected to the contact 340, which is exposed from the internal housing 330, and the GND shell 310. The impedance adjuster 360 is disposed in the spatial layer 395 that is formed between the exposed part and the GND shell 310.

### <EMI Shell>

The EMI shell 370 contains a conductor as a material. For example, the EMI shell 370 contains a metal. Note that the EMI shell 370 may contain a material other than a metal as long as it contains a conductor. The EMI shell 370 has a semicylinder shape. The EMI shell 370 is joined to the GND shell 310. The EMI shell 370 is thereby electrically connected to the ground potential. The EMI shell 370 covers a part of the GND shell 310. For example, the EMI shell 370 covers a clearance 311 of the GND shell 310. Thus, the EMI shell 370 has a part that covers the clearance 311 of the GND shell 310. The details of the EMI shell 370 will be described later, together with an EMI shell 470 of the connector 400.

### <External Housing>

An assembly of the GND shell 310, the internal housing 330, the contact 340, the sleeve 350, the impedance adjuster 360, and the EMI shell 370 is mounted inside the external housing 380.

### <Cable>

The cable 390 includes the core wire 391, the coating 392, the shield 393, and the outside cover 394. The structures and functions of the core wire 391, the coating 392, the shield 393, and the outside cover 394 in the cable 390 are the same as the structures and functions of the core wire 191, the coating 192, the shield 193, and the outside cover 194 in the cable 190, respectively.

### <Female-Side Connector>

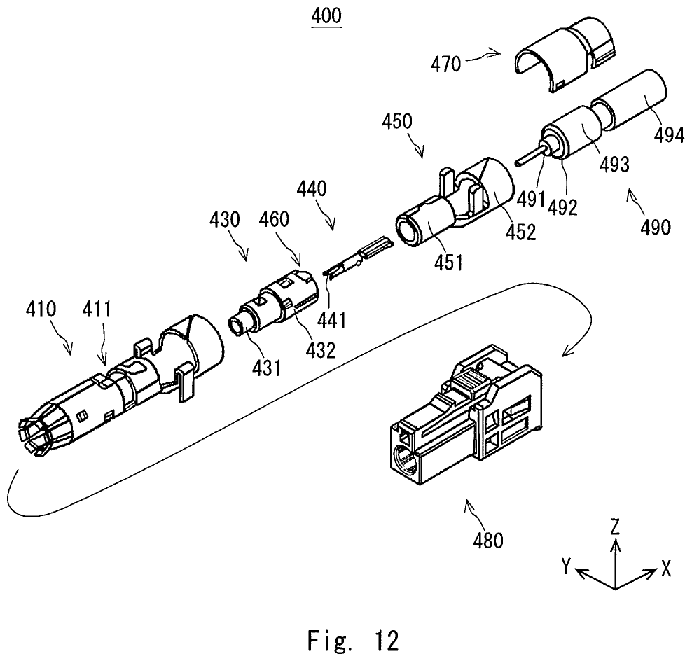

The connector 400 on the female side is described hereinafter. FIG. 12 is an exploded perspective view illustrating each member constituting the connector 400 in the relay connector device 30 according to the first embodiment. As shown in FIG. 8, FIG. 10, and FIG. 12, the connector 400 includes a GND shell 410, an internal housing 430, a contact 440, a sleeve 450, an impedance adjuster 460, an EMI shell 470, and an external housing 480.

In the case of the connector 300, the cable 390 is located on the −x axis direction side of the connector 300, whereas in the case of the connector 400, the cable 490 is located on the +x axis direction side of the connector 400. Otherwise, the basic structures and functions of the GND shell 410, the internal housing 430, the contact 440, the sleeve 450, the impedance adjuster 460, the EMI shell 470, and the external housing 480 of the connector 400 are the same as the structures and functions of the GND shell 310, the internal housing 330, the contact 340, the sleeve 350, the impedance adjuster 360, the EMI shell 370, and the external housing 380 of the connector 300, respectively.

### <GND Shell>

The internal housing 430, the contact 440, and the impedance adjuster 460 are disposed inside the GND shell 410. Further, the sleeve 450 and a part of the cable 490 are disposed inside the GND shell 410. The internal housing 430 may be press-fit to the inside of the GND shell 410.

An end of the GND shell 410 on the −x axis direction side is disposed in close proximity to an end of the internal housing 430 on the −x axis direction side. On the other hand, an end of the GND shell 410 on the +x axis direction side is located above an outside cover 494 of the cable 490. The position on the x axis of the end of the GND shell 410 on the +x axis direction side may coincide with that of an end of the sleeve 450 on the +x axis direction side.

### <Internal Housing>

A part of the internal housing 430 on the +x axis direction side incorporates a part of the impedance adjuster 460 on the −x axis direction side. The internal housing 430 is disposed inside the GND shell 410. The contact 440 is disposed inside the internal housing 430. Thus, the internal housing 430 supports the contact 440 inside in such a way that one end of the contact 440 is exposed.

The internal housing 430 includes a first part 431 and a second part 432. The first part 431 is disposed on the −x axis direction side of the second part 432. The first part 431 and the second part 432 have a cylindrical shape whose center axis coincides with the center axis of the internal housing 430. The outside diameter of the first part 431 is smaller than the outside diameter of the second part 432. The first part 431 mates with the recess 331 of the internal housing 330 of the connector 300. When the first part 431 mates with the recess 331, the projection 341 of the contact 340 of the connector 300 mates with a recess 441 of the contact 440 of the connector 400.

An end of the internal housing 430 on the −x axis direction side is an end surface of the first part 431 on the −x axis direction side. The end of the internal housing 430 on the −x axis direction side is disposed in close proximity to an end of the GND shell 410 on the −x axis direction side. For example, the position on the x axis of the end of the internal housing 430 on the −x axis direction side may coincide with that of the end of the GND shell 410 on the −x axis direction side. The recess 441 on the −x axis direction side of the contact 440 is disposed inside the first part 431.

An end of the internal housing 430 on the +x axis direction side is disposed in close proximity to an end of the contact 440 on the +x axis direction side. For example, the position on the x axis of the end of the internal housing 430 on the +x axis direction side may coincide with that of another end of the contact 440 on the +x axis direction side. A core wire 491 of the cable 490 is connected to the end of the contact 440 on the +x axis direction side. A connection part between the contact 440 and the core wire 491 of the cable 490 may be disposed inside the internal housing 430.

### <Contact>

The contact 440 has the recess 441 at one end on the −x axis direction side. The contact 440 is disposed inside the internal housing 430. An end of the contact 440 on the +x axis direction side is connected to the core wire 491 of the cable 490. The projection 341 of the contact 340 in the connector 300 on the male side mates with the recess 441 of the contact 440 in the connector 400 on the female side.

### <Sleeve>

The sleeve 450 includes a first part 451 in cylindrical shape and a second part 452 in cylindrical shape. The first part 451 is disposed on the −x axis direction side of the second part 452. The outside diameter of the first part 451 is smaller than the outside diameter of the second part 452. The inside diameter of the first part 451 is smaller than the inside diameter of the second part 452.

The first part 451 is disposed inside the GND shell 410. The first part 451 covers a shield 493 that is exposed from an end of the outside cover 494 of the cable 490. The second part 452 covers the outside cover 494 of the cable 490. A connection part between the first part 451 and the second part 452 is thus located in close proximity to an end of the outside cover 494.

### <Impedance Adjuster>

The impedance adjuster 460 has a part incorporated into the internal housing 430. To be specific, for example, a part of the impedance adjuster 460 on the −x axis direction side is incorporated into a part of the internal housing 430 on the +x axis direction side.

The impedance adjuster 460, together with the internal housing 430 and the contact 440, is disposed inside the GND shell 410. An end of the impedance adjuster 460 on the −x axis direction side is located inside the internal housing 430. An end of the impedance adjuster 460 on the +x axis direction side is located above a coating 492 of the cable 490. An end of the coating 492 on the −x axis direction side of the cable 490 is a cut surface. Thus, the impedance adjuster 460 covers the end of the coating 492.

The impedance adjuster 460 covers an exposed part of the core wire 491 connected to the contact 440, which is exposed from the internal housing 430. A spatial layer 495 is formed between the exposed part of the core wire 491 connected to the contact 440, which is exposed from the internal housing 430, and the GND shell 410. The impedance adjuster 460 is disposed in the spatial layer 495 that is formed between the exposed part and the GND shell 410.

### <EMI Shell>

The EMI shell 470 is joined to the GND shell 410 and covers a part of the GND shell 410. For example, the EMI shell 470 has a part that covers a clearance 411 of the GND shell 410. The structures and functions of the EMI shell 470 are the same as the structures and functions of the EMI shell 370. The details of the EMI shell 370 and the EMI shell 470 are described hereinafter.

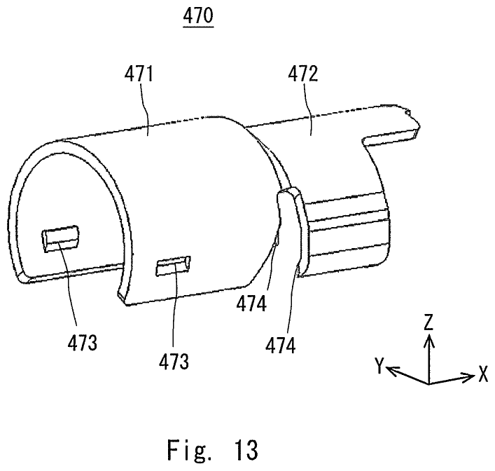

FIG. 13 is a perspective view illustrating the EMI shell 470 in the relay connector device 30 according to the first embodiment. As shown in FIG. 13, the EMI shell 470 has a semicylinder shape. The EMI shell 470 is disposed in such a way that its center axis is in the x axis direction.

The EMI shell 470 may include a first part 471 and a second part 472. The first part 471 has a semi-tubular shape where a part of its side surface is cut. For example, the cross section orthogonal to the center axis of the first part 471 includes a U-shape or a horseshoe shape. The second part 472 also has a semi-tubular shape where a part of its side surface is cut. For example, the cross section orthogonal to the center axis of the second part 472 also includes a U-shape or a horseshoe shape. The first part 471 and the second part 472 are integrally formed. Note that a part of the first part 471 on the +x axis direction side and a part of the second part 472 on the −x axis direction side may be connected to each other.

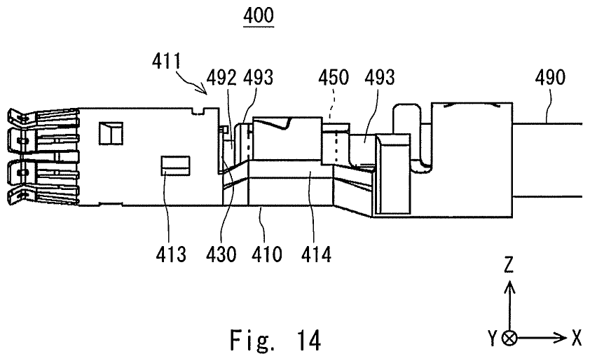

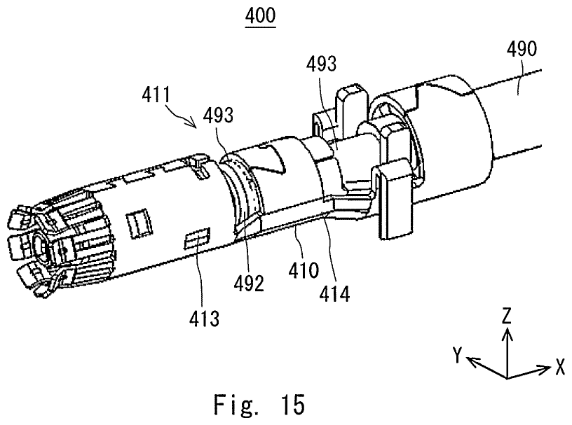

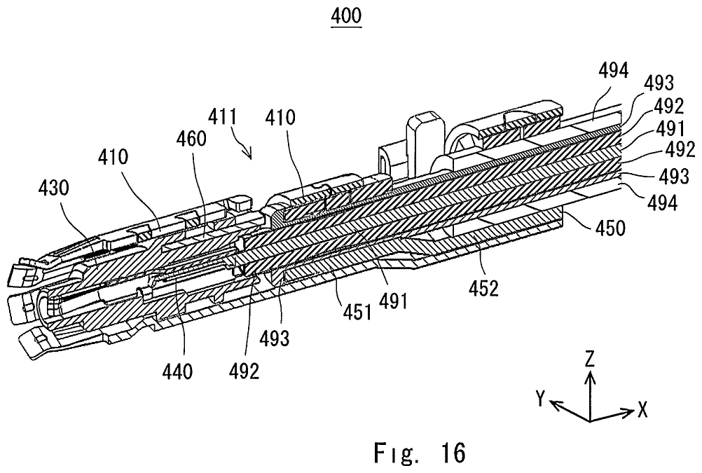

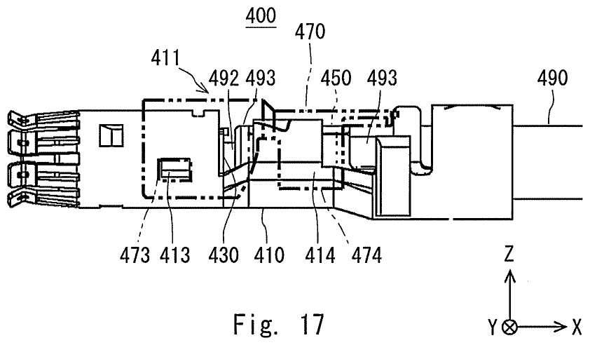

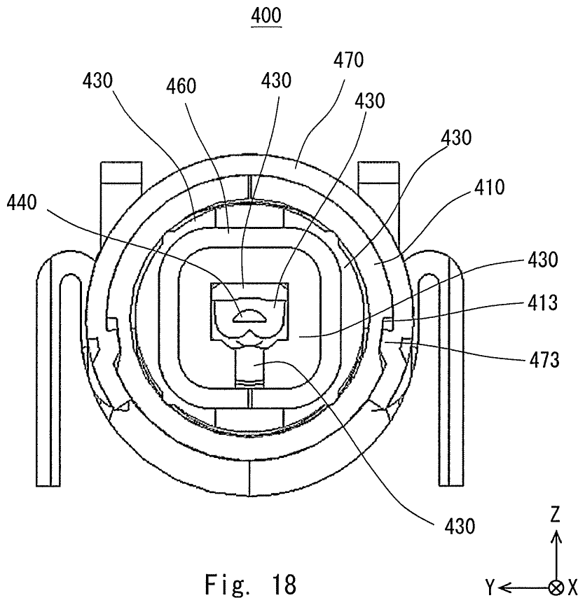

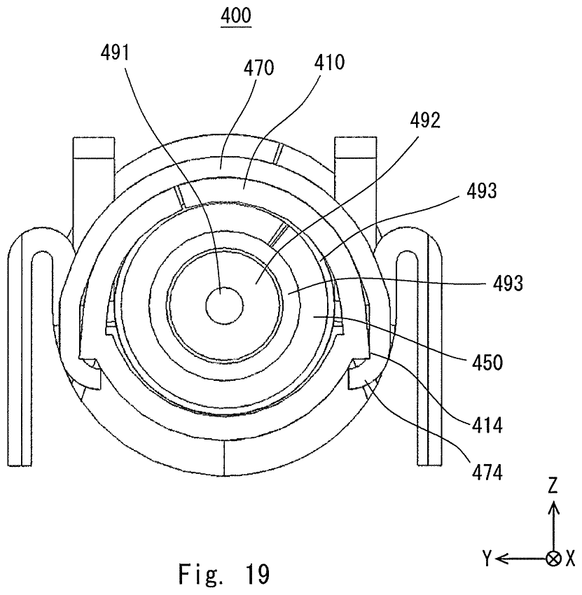

FIG. 14 is a side view illustrating the connector 400 from which the EMI shell 470 is removed in the relay connector device 30 according to the first embodiment. FIG. 15 is a perspective view illustrating the connector 400 from which the EMI shell 470 is removed in the relay connector device 30 according to the first embodiment. FIG. 16 is a cross-sectional perspective view illustrating the connector 400 from which the EMI shell 470 is removed in the relay connector device 30 according to the first embodiment. FIG. 17 is a side view illustrating the connector 400 in the relay connector device 30 according to the first embodiment, where the EMI shell 470 is shown transparent. FIG. 18 is a sectional view illustrating the connector 400 in the relay connector device 30 according to the first embodiment, which shows a cross section XVIII in FIG. 10. FIG. 19 is a sectional view illustrating the connector 400 in the relay connector device 30 according to the first embodiment, which shows a cross section XIX in FIG. 10.

As shown in FIGS. 13 to 19, the EMI shell 470 covers, from outside, the GND shell 410, the internal housing 430, the contact 440, the sleeve 450, the core wire 491 of the cable 490, the coating 492, and the shield 493. The first part 471 covers the internal housing 430 with the GND shell 410 interposed therebetween. In other words, the first part 471 covers a part of the GND shell 410 which covers the internal housing 430. The second part 472 covers the sleeve 450 with the GND shell 410 interposed therebetween. In other words, the second part 472 covers a part of the GND shell 410 which covers the sleeve 450. An end of the EMI shell 470 on the +x axis direction side is located above the GND shell 410. An end of the EMI shell 470 on the −x axis direction side is also located above the GND shell 410.

As shown in FIGS. 14 to 16, in the state where the EMI shell 470 is removed, the GND shell 410 has the clearance 411, just like in the relay connector device 10 according to the comparative example. On the other hand, as shown in FIG. 17, the EMI shell 470 covers this clearance 411 of the GND shell 410. The EMI shell 470 covers at least any one of the internal housing 430, the end of the contact 440 exposed from the internal housing 430, and the core wire 491 connected to the other end of the contact 440 in the clearance 411 of the GND shell 410. Further, the EMI shell 470 may cover at least any one of the internal housing 430, the contact 440 exposed from the internal housing 430, the coating 492 exposed from the shield 493, and the core wire 491 exposed from the coating 492 in the clearance 411 of the GND shell 410. In this structure, the EMI shell 470 allows controlling the leakage of noise to the outside.

As shown in FIGS. 14 and 15, the GND shell 410 includes retention parts 413 and 414. The retention part 413 is on an outer surface of a part of the GND shell 410 which covers the internal housing 430. The retention part 414 is on an outer surface of a part of the GND shell 410 which covers the sleeve 450. The retention part 413 and the retention part 414 have a recessed shape, for example. Note that the retention parts 413 and 414 may have a projecting shape as long as they mate with a retention part 473 and a retention part 474 of the EMI shell 470, respectively.

The retention part 414 of the GND shell 410 may be formed during crimping on the GND shell 410 that covers the sleeve 450. For example, a part of the GND shell 410 that covers the sleeve 450 is crimped. In this process, the part of the GND shell 410 that covers the sleeve 450 is compressed in the z axis direction so that both sides in the y axis direction are depressed, and thereby the retention part 414 in recessed shape is formed. In this manner, the GND shell 410 may have the retention part 414 formed by crimping.

On the other hand, as shown in FIG. 13, the EMI shell 470 includes the retention parts 473 and 474. The retention part 473 is on the inner surface of the first part 471 of the EMI shell 470. The retention part 474 is at the lower end of the second part 472.

As shown in FIGS. 17 to 19, the retention part 473 mates with the retention part 413 of the GND shell 410. The retention part 474 mates with the retention part 414 of the GND shell 410. The connector 400 thereby holds the EMI shell 470 to the GND shell 410.

The width of the first part 471 of the EMI shell 470 in a specified direction orthogonal to the x axis direction may be different from the width of the second part 472 in the specified direction. The specified direction is the z axis direction, for example. For example, the outside diameter of a part of the GND shell 410 which covers the internal housing 430 is greater than the outside diameter of a part of the GND shell 410 which covers the sleeve 450. The part of the GND shell 410 which covers the sleeve 450 is crimped as described above. Thus, the width of this part in the z axis direction is smaller than the width of the part covering the internal housing 430 in the z axis direction. Thus, in the EMI shell 470, the width of the first part 471 in the z axis direction is greater than the width of the second part 472 in the z axis direction.

Note that, in the case where the outside diameter of the part of the GND shell 410 which covers the sleeve 450 is greater than the outside diameter of the part of the GND shell 410 which covers the internal housing 430, the width of the first part 471 in the z axis direction may be smaller than the width of the second part 472 in the z axis direction. Further, in the case where the outside diameter of the part of the GND shell 410 which covers the sleeve 450 is the same as the outside diameter of the part of the GND shell 410 which covers the internal housing 430, the width of the first part 471 in the z axis direction in the EMI shell 470 may be the same as the width of the second part 472 in the z axis direction.

The EMI shell 470 in the connector 400 is described above, and the same applies to the EMI shell 370 in the connector 300.

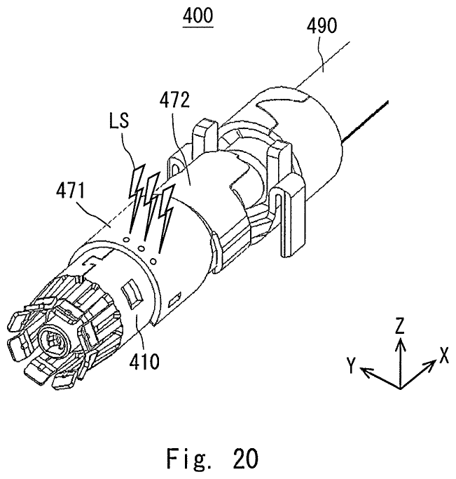

FIG. 20 is a perspective view illustrating the connector 400 in the relay connector device 30 according to the first embodiment. In FIG. 20, the position of laser welding with a laser LS is shown. As shown in FIG. 20, the EMI shell 470 is joined to the GND shell 410. By joining the EMI shell 470 to the GND shell 410, an electrical connection is improved. This allows reliably setting the EMI shell 470 at the ground potential. For example, the EMI shell 470 may be joined to the GND shell 410 by laser welding with the laser LS. Laser welding allows reducing the time to join the EMI shell 470. The EMI shell 470 is preferably joined to the GND shell 410 near an edge of the EMI shell 470 on the −x axis direction side. To be specific, the EMI shell 470 is preferably joined to the GND shell 410 in close proximity to an edge of the first part 471 on the −x axis direction side. This allows the potential of the EMI shell 470 to be closer to the ground potential, thereby improving the EMC.

### <External Housing>

An assembly of the GND shell 410, the internal housing 430, the contact 440, the sleeve 450, the impedance adjuster 460, and the EMI shell 470 is mounted inside the external housing 480.

### <Cable>

The cable 490 includes the core wire 491, the coating 492, a shield 493, and the outside cover 494. The structures and functions of the core wire 491, the coating 492, the shield 493, and the outside cover 494 in the cable 490 are the same as the structures and functions of the core wire 391, the coating 392, the shield 393, and the outside cover 394 in the cable 390, respectively. Note that, however, the direction in which the core wire 491 connects to the contact 440, the direction of the end surface of the coating 492 having the cut surface, the direction of the end of the shield 493 and the direction in which it is folded, the direction of the end surface of the outside cover 494 and the like are opposite to those in the cable 390.

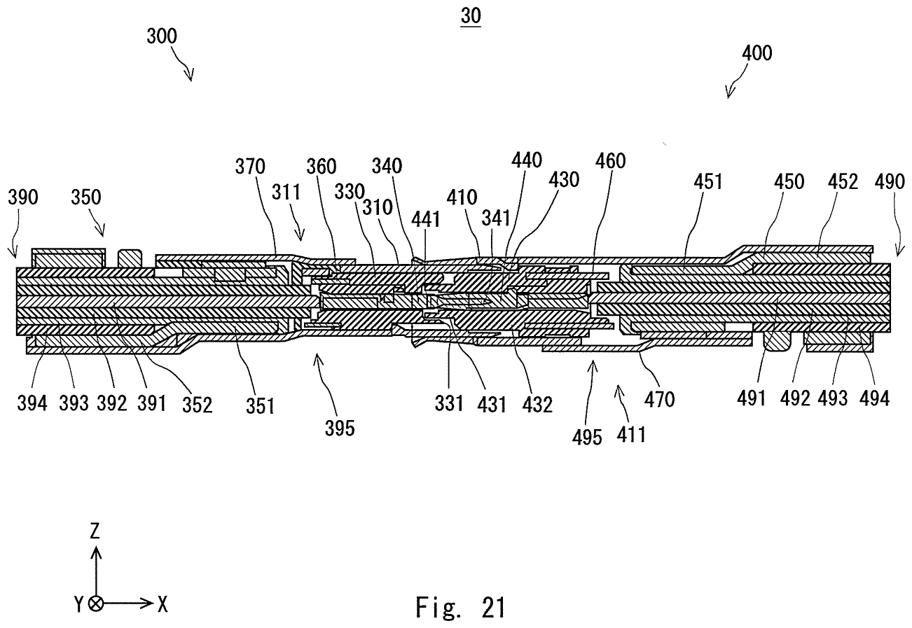

The operation of connection of the relay connector device 30 according to this embodiment is described hereinafter. FIG. 21 is a sectional view illustrating the operation of connecting the connectors 300 and 400 in the relay connector device 30 according to the first embodiment. As shown in FIGS. 8 and 21, in the relay connector device 30 according to this embodiment, the connector 300 and the connector 400 are opposed to each other. Then, the projection 341 of the contact 340 mates with the recess 441 of the contact 440. A transmission path of a high-frequency signal is thereby formed between the contact 340 and the contact 440. At the same time, the first part 431 of the internal housing 430 mates with the recess 331 of the internal housing 330. Further, the GND shell 310 and the GND shell 410 come into contact with each other. The EMI shells 370 and 470 cover the clearance 311 of the GND shell 310 and the clearance 411 of the GND shell 410, respectively. A shield that covers the transmission path of a high-frequency signal is thereby formed.

An advantageous effect of this embodiment is described hereinafter. The relay connector device 30 according to this embodiment includes the EMI shells 370 and 470. The EMI shells 370 and 470 cover the clearance 311 of the GND shell 310 and the clearance 411 of the GND shell 410, respectively. The EMC is thereby improved.

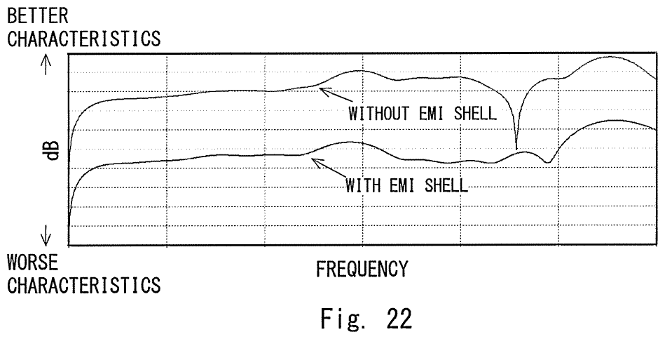

FIG. 22 is a graph illustrating EMI (Electromagnetic Interference) characteristics in the relay connector device 30 according to the first embodiment, where the horizontal axis indicates the frequency of a signal and the vertical axis indicates the magnitude of a signal in decibel (dB). The EMI characteristics are better as the magnitude in the vertical axis decreases. As shown in FIG. 22, the EMI characteristics of the relay connector device 30 according to the first embodiment with the EMI shells 370 and 470 are better than the EMI characteristics of the relay connector device 10 according to the comparative example without the EMI shells 370 and 470. The EMI shells 370 and 470 are hereinafter referred to as the EMI shell 370 etc. unless otherwise specified. In some cases, the EMI shells 370 and 470 are referred to as the EMI shell 470 etc. in order to correspond to a figure. Likewise, the other members of the connector 300 and the connector 400 are also abbreviated in some cases.

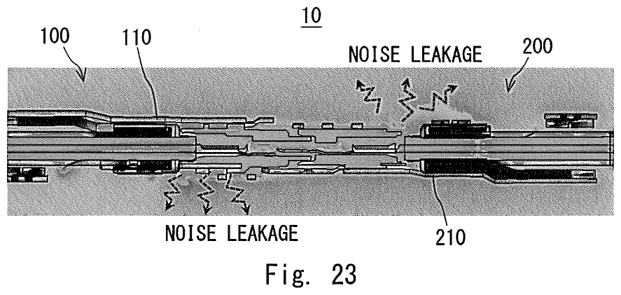

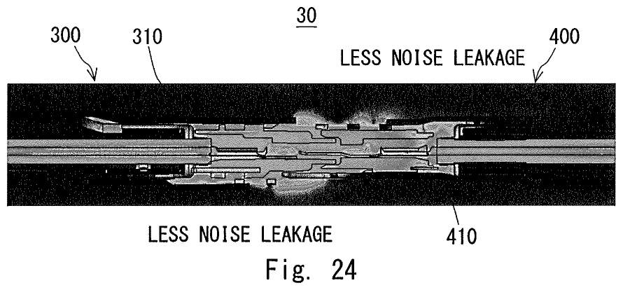

FIG. 23 is a view illustrating noise leakage to the outside in the relay connector device 10 according to the comparative example. FIG. 24 is a view illustrating noise leakage to the outside in the relay connector device 30 according to the first embodiment. As shown in FIG. 23, the leakage of noise to the outside is significant in the relay connector device 10 according to the comparative example, which is not provided with the EMI shell 370 etc. On the other hand, as shown in FIG. 24, in the relay connector device 30 according to the first embodiment, which is provided with the EMI shell 370 etc., the EMI shell 370 etc. control the leakage of noise to the outside. The EMI characteristics are thereby improved.

The EMI shells 370 and 470 are joined to the GND shells 310 and 410, respectively. This allows the EMI shells 370 etc. to be reliably set at the ground potential.

The EMI shell 370 etc. may be joined to the GND shell 310 etc. by laser welding. Laser welding allows reducing the time to join the EMI shell 370 etc. and thereby reducing the time taken to manufacture the relay connector device 30. The EMI shells 370 and 470 are joined in close proximity to the edge of the GND shell 310 on the +x axis direction side and the edge of the GND shell 410 on the −x axis direction side, respectively. This allows the potential of the EMI shell 370 etc. to be closer to the ground potential and thereby improves the EMC.

The width of the first part 471 of the EMI shell 470 etc. in a specified direction orthogonal to the axial direction is different from the width of the second part 472 in the specified direction. For example, a part of the GND shell 410 etc. which covers the sleeve 450 is narrower than a part of the GND shell 410 etc. which covers the internal housing 430 due to crimping. The width of the second part 472 in the z axis direction in the EMI shell 470 etc. is thereby smaller than the width of the first part 471 in the z axis direction. In this manner, since the size of the EMI shell 370 etc. is varied according to the size of the GND shell 310 etc., the clearance 311 etc. is efficiently closed, which improves the EMC.

The GND shell 410 etc. includes the retention parts 413 and 414, and the EMI shell 470 etc. includes the retention parts 473 and 474. The retention parts 413 and 414 mate with the retention parts 473 and 474. This secures a connection between the GND shell 410 etc. and the EMI shell 470 etc. Further, the retention part 414 of the GND shell 410 etc. may be formed by crimping. This allows simultaneously forming the retention part 414 and crimping the GND shell 410 etc., which reduces the manufacturing process. Further, since the width of the second part 472 of the EMI shell 470 coincides with the width of the GND shell 410 after crimping, the clearance 411 of the GND shell 410 is efficiently closed.

The impedance adjuster 360 etc. are incorporated into the internal housing 330 etc. This allows fixing the size and shape of the impedance adjuster 360 etc. and thereby improves the stability of the impedance.

Further, the impedance adjuster 360 etc. in the relay connector device 30 according to this embodiment are disposed in the spatial layer 395 that is formed between the exposed part of the core wire 391 etc. and the GND shell 310 etc. This allows controlling an increase in impedance in the core wire 391 etc. of the cable 390 etc. exposed in the spatial layer 395 etc. containing air. This further improves the impedance matching.

The impedance adjuster 360 etc. have a tube shape with its center axis located at the contact 340 etc. and the core wire 391 etc. This allows covering up the contact 340 etc. and the core wire 391 etc. in an isotropic manner and thereby equally adjusting the impedance.

The impedance adjuster 360 etc. may be incorporated into the internal housing 330 etc. by insert molding. This allows securely fixing the impedance adjuster 360 etc. to the internal housing 330 etc. On the other hand, the impedance adjuster 360 etc. may be incorporated into the internal housing 330 etc. by being press-fit into the internal housing 330 etc. This allows easily incorporating the impedance adjuster 360 etc. into the internal housing 330 etc.

Although an embodiment of the present disclosure is described in the foregoing, the present disclosure involves appropriate modifications without impairment of its object and effects and is not restricted to the above-described embodiment. Further, the structures in the comparative example and the first embodiment may be appropriately combined.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A coaxial cable connector for connecting a cable, comprising:
a contact containing a conductor as a material and extending in an axial direction;
an insulator body containing an insulator as a material and supporting the contact in such a way that one end of the contact is exposed;
a GND shell containing the conductor as the material and having a part covering at least part of the insulator body; and
an EMI shell containing the conductor as the material and having a part covering a clearance of the GND shell,
wherein the EMI shell covers, in the clearance, at least any one of the insulator body, the contact exposed from the insulator body, and a core wire of the cable connected to another end of the contact.

2. The coaxial cable connector according to claim 1, wherein
the cable includes:
the core wire containing the conductor as the material and connected to the another end of the contact;
a coating containing the insulator as the material and having a part covering the core wire;
a shield containing the conductor as the material and having a part covering the coating; and
an outside cover containing the insulator as the material and having a part covering the shield, and
the EMI shell covers, in the clearance, at least any one of the insulator body, the contact exposed from the insulator body, the coating exposed from the shield, and the core wire exposed from the coating and connected to the another end of the contact.

3. The coaxial cable connector according to claim 2, further comprising:
a sleeve having a part covering the shield exposed from the outside cover, wherein
the EMI shell includes:
a first part covering the insulator body with the GND shell interposed therebetween; and
a second part covering the sleeve with the GND shell interposed therebetween, and
a width of the first part in a specified direction orthogonal to the axial direction is different from a width of the second part in the specified direction.

4. The coaxial cable connector according to claim 1, wherein
the GND shell includes a first retention part, and
the EMI shell includes a second retention part configured to mate with the first retention part.

5. The coaxial cable connector according to claim 3, wherein
the GND shell includes a first retention part formed by crimping, and
the second part of the EMI shell includes a second retention part configured to mate with the first retention part.

6. The coaxial cable connector according to claim 1, wherein the EMI shell is joined to the GND shell.

7. The coaxial cable connector according to claim 6, wherein the EMI shell is joined to the GND shell by laser welding.

8. The coaxial cable connector according to claim 6, wherein the EMI shell is joined to the GND shell in close proximity to an edge on one end of the EMI shell.
